(19) United States
(12) Patent Application Publication
(10) Pub. No.: US 2015/0317969 A1
(43) Pub. Date: Nov. 5, 2015

(54) BUZZER CIRCUIT

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: YONG-ZHAO HUANG, Wuhan (CN)

(21) Appl. No.: 14/573,409

(22) Filed: Dec. 17, 2014

(30) Foreign Application Priority Data
Apr. 30, 2014 (CN) 201410179577.3

(51) Int. Cl. G10K 9/12

(52) U.S. Cl. CPC G10K 9/12

(57) ABSTRACT

A buzzer circuit includes a control unit, a constant current unit, and a buzzer. The buzzer circuit is coupled to a drive circuit. The buzzer includes a power pin and a ground pin. The constant current unit includes a constant voltage component and a first resistor. When the power pin of the buzzer receives a high level drive signal, the constant voltage component provides a constant voltage, controlled by the control unit, to the first resistor, and the ground pin is coupled to ground through the first resistor, and the buzzer buzzes steadily.

### FIELD

The subject matter herein generally relates to a buzzer circuit.

### BACKGROUND

A current of a traditional buzzer changes over time, which results in an unsteady sound from the buzzer.

### BRIEF DESCRIPTION OF THE DRAWINGS

Implementations of the present technology will now be described, by way of example only, with reference to the attached figures.

FIG. 1 is a circuit diagram of a first embodiment of a buzzer circuit.

FIG. 2 is a circuit diagram of a second embodiment of the buzzer circuit.

FIG. 3 is a circuit diagram of a third embodiment of the buzzer circuit.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a buzzer circuit.

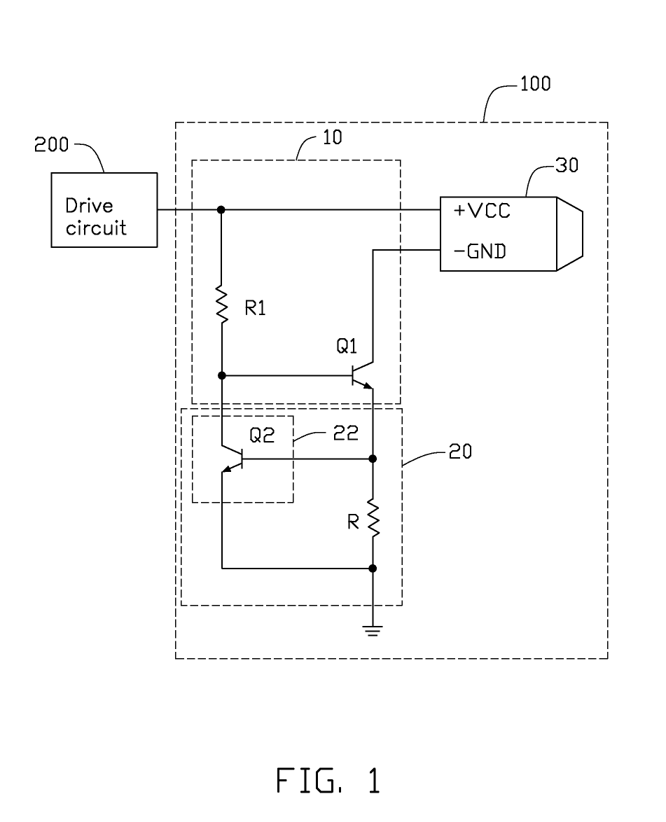

FIG. 1 illustrates a first embodiment of the buzzer circuit 100. A drive circuit 200 is coupled to the buzzer circuit 100 for energizing the buzzer circuit 100. The buzzer circuit 100 can comprise a control unit 10, a constant current unit 20, and a buzzer 30.

The buzzer 30 can comprise a power pin VCC and a ground pin GND. The power pin VCC is coupled to the drive circuit 200.

The control unit 10 can comprise a resistor R1 and an electronic switch Q1. A control terminal of the electronic switch Q1 is coupled to the power pin VCC of the buzzer 30 through the resistor R1. A first terminal of the electronic switch Q1 is coupled to the ground pin GND of the buzzer 30. A second terminal of the electronic switch Q1 is coupled to the constant current unit 20.

The constant current unit 20 can comprise a constant voltage component 22 and a resistor R. In at least one embodiment, the constant voltage component 22 is a bipolar junction transistor Q2. A base of the bipolar junction transistor Q2 is coupled to the second terminal of the electronic switch Q1. The base of the bipolar junction transistor Q2 is also coupled to ground through the resistor R. A collector of the bipolar junction transistor Q2 is coupled to the control terminal of the electronic switch Q1. An emitter of the bipolar junction transistor Q2 is coupled to ground.

The power pin VCC of the buzzer 30 receives a high level drive signal when the drive circuit 200 outputs a high level signal. At the same time, the electronic switch Q1 and the bipolar junction transistor Q2 is turned on. The ground pin GND of the buzzer 30 is coupled to ground through the first terminal and the second terminal of the electronic switch Q1 and the resistor R in that order. A voltage of the second terminal of the electronic switch Q1 is equal to a voltage between the base and the emitter of the bipolar junction transistor Q2. Vbe stands for the voltage between the base and the emitter of the bipolar junction transistor Q2, r stands for a resistance of the resistor R, I stands for an operating current of the buzzer 30 and for a current flowing through the resistor R, and I is defined by the equation I=Vbe/r. Voltage Vbe is a constant value when the bipolar junction transistor Q2 is turned on, and the operating current I is constant. The buzzer 30 buzzes steadily.

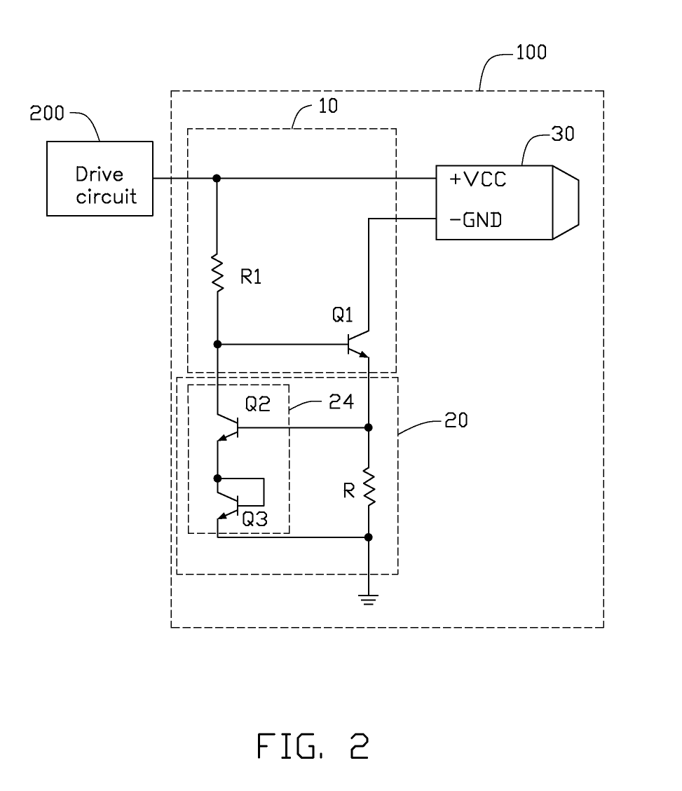

FIG. 2 illustrates a second embodiment of the buzzer circuit 100. The constant voltage component 22 can further comprise a bipolar junction transistor Q3 compared to the first embodiment. A base of the bipolar junction transistor Q3 is coupled to the emitter of the bipolar junction transistor Q2. A collector of the bipolar junction transistor Q3 is coupled to the emitter of the bipolar junction transistor Q2. An emitter of the bipolar junction transistor Q3 is coupled to ground. The operating current I of the buzzer 30 is defined by the equation I=2Vbe/r.

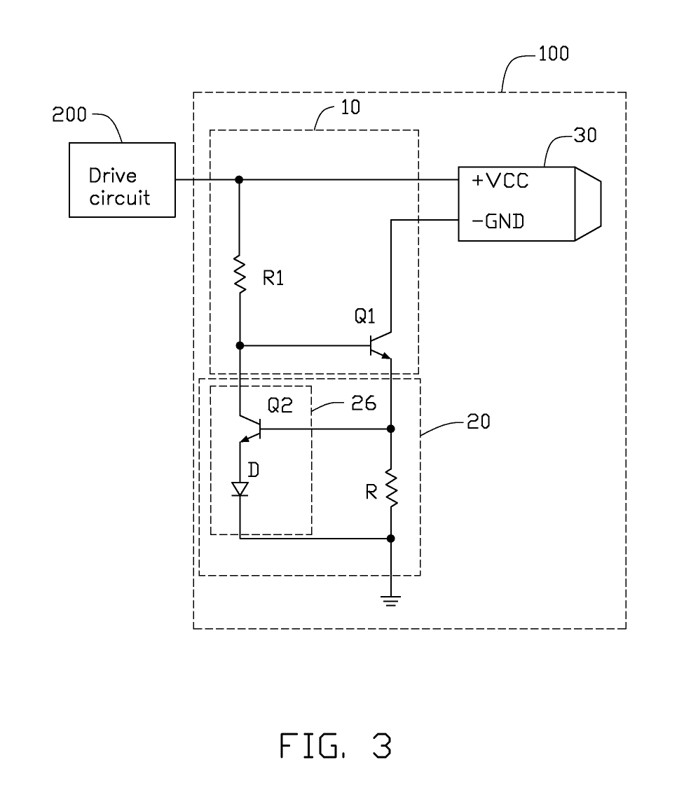

FIG. 3 illustrates a third embodiment of the buzzer circuit 100. The constant voltage component 22 can further comprise a diode D compared to the first embodiment. An anode of the diode D is coupled to the emitter of the bipolar junction transistor Q2. A cathode of the diode D is coupled to ground. When VD stands for a forward voltage of the diode D, then the operating current I of the buzzer 30 is defined by the equation I=(Vbe+VD)/r.

In the other embodiments, the operating current I of the buzzer 30 can be changed through adding the bipolar junction transistor Q3 or the diode D. The operating current I of the buzzer 30 can also be changed through changing the resistance of the resistor R.

In at least one embodiment, the electronic switch Q1 and the bipolar junction transistors Q2, Q3 can be NPN bipolar junction transistors.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A buzzer circuit coupled to a drive circuit, the buzzer circuit comprising:
a buzzer comprising a power pin and a ground pin, wherein the power pin is coupled to the drive circuit for receiving a drive signal from the drive circuit;
a constant current unit comprising a constant voltage component and a first resistor; and
a control unit coupled between the buzzer and the constant current unit;
the buzzer circuit configured such that when the power pin of the buzzer receives a high level drive signal, the constant voltage component provides a constant voltage, controlled by the control unit, to the first resistor, and the ground pin is coupled to ground through the first resistor.

2. The buzzer circuit of claim 1, wherein the constant voltage component comprises an NPN bipolar junction transistor, a base of the bipolar junction transistor is coupled to the control unit, the base of the bipolar junction transistor is coupled to ground through the first resistor, a collector of the bipolar junction transistor is coupled to the control unit, and an emitter of the bipolar junction transistor is coupled to ground.

3. The buzzer circuit of claim 1, wherein the constant voltage component comprises a first and a second NPN bipolar junction transistors, a base of the first bipolar junction transistor is coupled to the control unit, the base of the first bipolar junction transistor is coupled to ground through the first resistor, a collector of the first bipolar junction transistor is coupled to the control unit, an emitter of the first bipolar junction transistor is coupled to a base of the second bipolar junction transistor, a collector of the second bipolar junction transistor is coupled to the emitter of the first bipolar junction transistor, and an emitter of the second bipolar junction transistor is coupled to ground.

4. The buzzer circuit of claim 1, wherein the constant voltage component comprises an NPN bipolar junction transistor and a diode, a base of the bipolar junction transistor is coupled to the control unit, the base of the bipolar junction transistor is coupled to ground through the first resistor, a collector of the bipolar junction transistor is coupled to the control unit, an emitter of the bipolar junction transistor is coupled to an anode of the diode, and a cathode of the diode is coupled to ground.

5. The buzzer circuit of claim 1, wherein the control unit comprises a second resistor and an electronic switch, a control terminal of the electronic switch is coupled to the power pin of the buzzer through the second resistor, a first terminal of the electronic switch is coupled to the ground pin of the buzzer, and a second terminal of the electronic switch is coupled to the constant current unit.

6. The buzzer circuit of claim 5, wherein the electronic switch is an NPN bipolar junction transistor.
